(19) United States
(12) Patent Application Publication
(10) Pub. No.: US 2026/0243123 A1
(43) Pub. Date: Aug. 20, 2026

(54) METHOD FOR CONTROLLING A MOTOR VEHICLE DOOR OR MOTOR VEHICLE FLAP

(71) Applicant: Kiekert Aktiengesellschaft, Heiligenhaus (DE)

(72) Inventors: Tobias KLOCKE, Mettmann (DE); Thorsten BENDEL, Oberhausen (DE)

(73) Assignee: Kiekert Aktiengesellschaft, Heiligenhaus (DE)

(21) Appl. No.: 18/876,674

(22) PCT Filed: May 22, 2023
(86) PCT No.: PCT/DE2023/100371

§ 371 Date: Dec. 19, 2024

(30) Foreign Application Priority Data
Jun. 24, 2022 (DE) 10 2022 115 828.4

(51) Int. Cl. E05F 15/73

(52) U.S. Cl. CPC E05F 15/73; E05Y 2400/3015; E05Y 2400/326; E05Y 2400/40; E05Y 2400/45; E05Y 2900/531

(57) ABSTRACT

The invention relates to a method and an associated device for controlling a motor vehicle door or motor vehicle flap. To this end, a drive (11) is provided for a leaf (2) of the motor vehicle door or motor vehicle flap that can be moved relative to a motor vehicle body (1). The invention also relates to a sensor (9, 10) for detecting individual or a plurality of static and/or dynamic parameters of the leaf (2) and a self-learning control unit (8) that evaluates values of the sensor (9, 10). According to the invention, the control unit (8) evaluates the parameters of the leaf (2) for the purpose of user identification.

The invention relates to a method for controlling a motor vehicle door or motor vehicle flap, with a drive for a leaf of the motor vehicle door or motor vehicle flap that can be moved relative to a motor vehicle body, furthermore with at least one sensor for detecting individual or a plurality of static and/or dynamic parameters of the leaf, and with a self-learning control unit that evaluates values of the sensor.

The control of motor vehicle doors or motor vehicle flaps, for example motor vehicle side doors, motor vehicle tailgates, or motor vehicle front hoods, is now often carried out entirely or partially with motorized assistance. For this purpose, the drive for the associated leaf, which can be moved relative to the vehicle body, is provided as the dominant component of the motor vehicle door or motor vehicle flap. The leaf can be a side door leaf, a tailgate leaf, or a front flap. In principle, other flaps or leaves are also conceivable, such as loading flaps, sliding doors, etc.

The drive of the movable leaf in question can be used both in connection with an associated opening movement of the leaf and in connection with a closing movement, or both. In both cases, i.e. during an opening process as well as during a closing process, vehicle users are accustomed to supporting or at least initiating the questionable movement of the leaf. As a result, only some of the energy required by the drive for the leaf is needed, and not all of it. This ultimately depends on how the individual vehicle user acts on the leaf.

There are already approaches in the prior art according to DE 10 2015 014 802 A1 to control and monitor the passenger door system using, for example, self-learning routines. This allows an opening and closing cycle to be adapted to an idealized opening and closing cycle, taking environmental parameter-related characteristic maps into account. This is intended to ensure reliable and convenient operation in a wide range of different ambient conditions. However, there is no adaptation to the individual user.

The generic prior art according to DE 10 2006 057 679 B4 relates to a device for closing a driven movable component, and in particular a tailgate or door on a motor vehicle. For this purpose, a first detector device is designed to signal a closed state of the component. With the help of a second detector device, a distance measurement is carried out as part of a switch-off device. In addition, a self-learning control system has been implemented. In fact, a plurality of closing processes can be examined in order to derive an average value for a delay time during the closing process. As a result, the delay time can be changed dynamically, for example as a function of the seasonal ambient temperature. Again, there is no adaptation to the user.

The invention is based on the technical problem of further developing such a method in such a way that conclusions about the user and their acting on the leaf of the motor vehicle door or motor vehicle flap can be drawn and implemented.

To solve this technical problem, a generic method for controlling a motor vehicle door or motor vehicle flap is characterized within the scope of the invention in that the control unit evaluates the parameters of the leaf for the purpose of user identification.

In most cases, the control unit proceeds in such a way that the dynamic parameters of the leaf are evaluated for the purpose of user identification. These dynamic parameters of the leaf include, for example, temporal curves of the leaf movement. This can be a distance-time curve, a speed-time curve, an acceleration-time curve, etc. individually or together. These dynamic parameters of the leaf are evaluated according to the invention for the purpose of user identification.

That is, based on the action on the leaf by the user during, for example, an opening and/or closing process, a specific path-time curve that is characteristic for that user and consequently also a speed-time curve and acceleration-time curve of the leaf during its closing or opening movements can be derived. This specific time curve of the user is now evaluated for the purpose of user identification and taken into account by the control unit. As a result, the control unit can not only perform a specific user identification based on the relevant time curve, but can also fundamentally distinguish between different users based on the time curve. Of course, averaging can be carried out to improve accuracy and for better distinguishability. For example, it is conceivable to first evaluate five or ten (or another number of) time curves when the user acts on the leaf of the motor vehicle door before a characteristic curve for the time curve is defined as user identification in the control unit. For further identification and user identification, signals from an upstream authentication check can of course also be taken into account.

In any case, the control unit can carry out the user identification implemented according to the invention on the basis of the dynamic parameters of the leaf and evaluate the parameters in question of the leaf for the purpose of user identification. As a result of this user identification, the control unit can then recalibrate the drive to act on the leaf. If, for example, a user acts particularly “vigorously” on the leaf in question during the opening and/or closing process, this may be implemented and interpreted by the control unit in such a way that not only is the user recognized, but the drive undergoes the desired recalibration as a function of the user recognition. In the example case, this means that the drive for the leaf is reduced in terms of the power exerted on the leaf.

Conversely, if a user only acts on the leaf “hesitantly,” the drive will be adjusted and, if necessary, recalibrated as a function of the user identification carried out, so that the drive almost exclusively moves the leaf.

In addition, or alternatively, it is possible for the control unit to take into account static parameters of the leaf, for example its mass. Such static parameters can, for example, be stored in the control unit by the manufacturer. As a result, when controlling the drive, the control unit takes into account not only the specific action of the user on the leaf in terms of user recognition, but also the mass of the leaf.

In addition, other parameters of the leaf can also be taken into account. For example, it is conceivable that the leaf or its movement sequence depends not only on the action exerted on it by the user, the previously described mass of the leaf, but also on the friction of the leaf against a bearing on the vehicle body. Ideally, the control unit can now differentiate between these different influencing factors, i.e. between the user, the mass of the leaf, and, finally, its friction in the bearing or the multiple bearings. This distinction can be made based on the movement sequence of the leaf, optionally taking into account additional and known values for the mass of the leaf.

User identification is usually carried out on the basis of the movement sequence over time, for example the maximum achievable speed, the speed curve, and the temporal decrease in the speed of the leaf as it was acted on by the user. In contrast, the friction between the leaf and the vehicle body has a largely static influence on the movement sequence in question, thus leading to a more or less large damping of its speed. The same applies to the mass. It is also possible to detect the stated static parameters of the leaf, such as, in particular, friction and mass, using a current sensor on the drive. This current sensor is used to determine the current consumed by the drive, which is a measure of the energy consumed by the drive to move the leaf. From the values of the current sensor, it can therefore be concluded that the mass of the leaf has increased under certain circumstances, as well as that the friction of the leaf in the bearing relative to the vehicle body has increased or decreased.

In contrast, a rotation angle sensor is primarily used to detect the dynamic parameters of the leaf, i.e. to make it possible to record and evaluate the movement sequence, described by way of example, in the form of a path-time curve. All of these values, i.e. the dynamic movement sequence of the leaf as a result of user recognition, any static parameters in the form of the mass of the leaf and its friction in the bearing with the vehicle body, are now implemented as a whole by the control unit so that the control unit recalibrates the drive to act on the leaf as a function of the values of the sensor to act on the leaf. In fact, values from both the current sensor and the rotation angle sensor are usually used at this point.

In addition, the control unit usually specifies different operating states as a function of the values of the sensor in question. That is, a distinction can be made, for example, between normal operation, load operation, or even overload operation. Normal operation corresponds to the situation in which the control unit acts on the drive to act on the leaf in such a way that it takes into account the user identification as well as the detected mass and friction, and the drive also has the necessary drive power for this. During load operation, the control unit ensures, for example, an increase in the drive power for the drive, which takes into account, or can take into account, for example, an increased friction of the leaf relative to the vehicle body. Finally, overload operation corresponds to the situation in which the friction and/or mass of the leaf have increased to such an extent that the nominal drive power of the drive is not (or is no longer) sufficient to move the leaf at all. In this case, the drive is not controlled by the control unit; rather, an error message is issued or overload operation is indicated.

The invention also relates to a device which is particularly suitable for carrying out the method. As a result, a method and a device are described with the aid of which, in particular, user identification can be carried out. For this purpose, the control unit usually carries out the user identification in question as a function of time-dependent values from the sensor. In addition to user identification as a result of recorded dynamic parameters of the leaf, the control unit usually also takes into account static parameters of the leaf in the form of its mass or the friction in one or more bearings with the vehicle body. As a result, the drive for acting on the leaf can be recalibrated in each case, or ultimately the energy required for the drive can be adjusted accordingly. All this is achieved through a learning process of the control unit as a function of the dynamic and static parameters of the leaf. The corresponding recalibration can be carried out and implemented through routines using, for example, artificial intelligence.

All this is achieved without the need for performing a calibration, for example at the end of production. In addition, the calibration carried out during operation in the example case takes into account any changes in the movement of the leaf, including with regard to the observed friction conditions. This provides an overall high-quality haptic operation of the leaf, which is particularly easy and simple to implement. These are the main advantages.

In the following, the invention is explained in more detail with the aid of a drawing showing only an exemplary embodiment; in the figures:

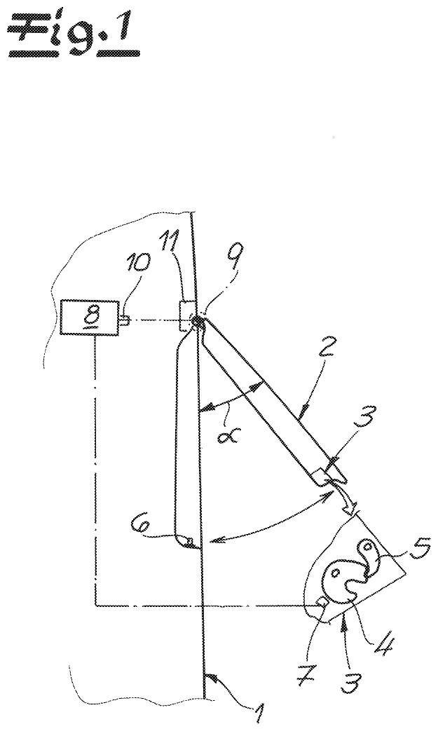

FIG. 1 schematically shows the device according to the invention for controlling a motor vehicle door or motor vehicle flap,

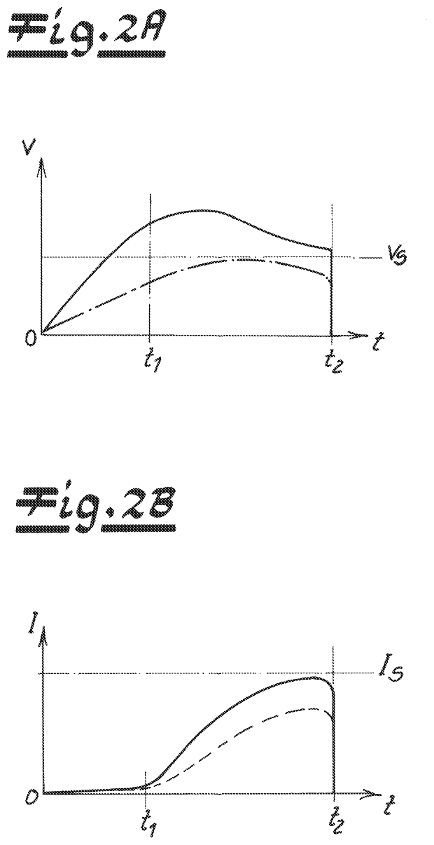

FIG. 2A shows a motion sequence in the form of a speed-time diagram of the corresponding leaf, and

FIG. 2B schematically shows the current consumed by the drive over time.

In the figures, a device for controlling a motor vehicle door or motor vehicle flap is shown. According to the embodiment, the device is one with the help of which a motor vehicle side door is controlled. For this purpose, the motor vehicle side door has a leaf 2 that can be moved relative to a motor vehicle body 1. The leaf 2 of the motor vehicle door or motor vehicle side door is also equipped with a motor vehicle lock 3, of which only a locking mechanism 4, 5 consisting of a rotary latch 4 and a pawl 5 interacting therewith is shown schematically. The motor vehicle lock 3, or its locking mechanism 4, 5, interacts with a body-side lock holder or locking clip 6. As soon as the motor vehicle lock 3 has assumed a closed state relative to the motor vehicle body and thus also the leaf 2 of the motor vehicle door, this is detected by means of at least one sensor 7 assigned to the locking mechanism 4, 5 and is transmitted to a control unit 8 which receives the signals from the sensor 7 and evaluates them. In addition, another sensor 9, 10 is realized.

In fact, there is a rotation angle sensor 9 on the one hand and a current sensor 10 on the other. In the example shown, the current I consumed by a drive 11 for the leaf 2 can be measured using the current sensor 10. With the help of the rotation angle sensor 9, an angle a made in each case by the leaf 2 relative to the vehicle body 1 can be determined.

The sensor 9, 10, or the two sensors 9, 10, record individual or multiple static and/or dynamic parameters of the leaf 2. The control unit 8 now evaluates the values of the sensor 9, 10 or of the angle of rotation sensor 9 as well as of the current sensor 10. According to the invention, the control unit 8 now evaluates the signals in question from the sensor 9, 10 and thus the parameters of the leaf 2 for the purpose of user recognition.

For this purpose, reference is made to FIG. 2A, which shows the movement sequence of the leaf 2, specifically two different curves of the speed v of the leaf 2 over time t. These two speed curves show a velocity v of the leaf 2 starting from the origin 0 and increasing differently over time t. After a time t₁ the drive 11 for the leaf 2 can in each case provide support for the closing movement of the leaf 2 shown at this point. This means that in the example shown in FIG. 2A, the leaf 2 is closed both manually and by motor. The time t₂ then corresponds to the closing state of the leaf 2, which is manifested by the closing state of the associated motor vehicle lock 3. This closing state is reported to the control unit 8 via the sensor 7.

In FIG. 2A, a speed threshold Vs is also marked. This speed threshold is not exceeded by a first user associated with the lower (dash-dotted) curve, but is exceeded by the second user associated with the upper (solid) curve. As a result, for example, the drive 11 can be operated by the first user with a speed curve below the threshold vₛ for supporting the closing movement of the leaf 2, whereas the closing movement of the leaf 2 for the second user above the threshold vₛ is not additionally supported by a motor. Of course, the threshold vₛ can be specified variably and displaceably by the control unit 8.

While the speed-time curve v(t) in FIG. 2A ultimately represents the signal of the rotation angle sensor 9, the curve of the current over time I(t) in FIG. 2B ultimately presents the values of the current sensor 10. In this case, the time t₁ corresponds to the fact that the current I consumed by the drive 11 increases at this point, up to a maximum at time t₂. That is, in the case in which the leaf 2 has reached its closed state relative to the motor vehicle body 1. This locking state is again detected by the sensor 7 inside the motor vehicle lock 3 and reported to the control unit 8.

According to the invention, the control unit 8 can now evaluate the parameters of the leaf 2, i.e. both the dynamic parameters of the leaf 2, i.e. its movement sequence according to FIG. 2A, and the static parameters of the leaf 2, i.e. its mass and, if applicable, friction relative to the motor vehicle body 1. For the purpose of user identification, the control unit 8 evaluates the dynamic parameters of the leaf 2, as can be seen from FIG. 2A. In fact, each user generates a movement profile or a characteristic movement sequence over time that are characteristic for that user, which is shown and reproduced here using the speed-time curve v(t). As a result, the control unit 8 can distinguish between different users. As a result, the control unit 8 “knows” that when the leaf 2 is acted on by the first user associated with the lower (dash-dotted) speed curve, the drive 11 must intervene in a supporting fashion, and that for the second user associated with the upper (solid) speed curve, additional support is not, or is hardly, required. In addition, the control unit 8 can take into account static parameters of the leaf 2 in the form of its mass. The current sensor 10 can provide information about this, as well as any friction in a bearing between the door leaf 2 and the vehicle body 1. In fact, the bearing is shown here as a schematic point at which the drive 11 for the leaf 2 acts.

Any increase in the mass of the leaf 2 and/or its friction in the bearing in question relative to the motor vehicle body 1 results in an increase in the current strength I measured by the current sensor 10 and received by the drive 11, as is schematically shown in FIG. 2B. In fact, two different operating states are shown here. The one operating state, which is associated with the dashed curve of the current strength I, corresponds to normal operation, whereas the solid curve of the current strength I over time t corresponds to load operation. In this load operation, the drive 11 in the example case is supplied with the maximum possible current strength. If an even higher current strength is required to supply the drive 11, for example due to increased friction, so-called overload operation is observed, which occurs beyond a threshold for the current Is in FIG. 2B.

This overload operation corresponds to the situation in which the control unit 8 does not act on the drive 11 for the leaf 2.

That is, the control unit 8 takes into account static parameters of the leaf 2 in the form of its mass or the friction relative to the motor vehicle body 1. The corresponding values are recorded using the current sensor 10, which is provided on the drive 11 and is provided to detect the static parameters of the leaf 2. As a result of these measurements, the control unit 8 ensures that the drive 11 is recalibrated as a function of the values of the sensor 9, 10 for acting on the leaf 2.

If, for example, the friction between the leaf 2 and the motor vehicle body 1 has increased, which corresponds to the load operation shown in solid lines in FIG. 2B, the control unit 8 allows a correspondingly increased current consumption of the drive 11, or ensures that the drive 11 and the action on it are recalibrated accordingly. As a result, the control unit 8 can specify, depending on the values of the sensor 9, 10, the different operating states already described in FIG. 2B, such as the dashed normal operation, the load operation shown in solid lines, and, finally, the overload operation beyond the threshold Iₛ.

### LIST OF REFERENCE SIGNS

1 Motor vehicle body
2 Door leaf
3 Motor vehicle lock
4,5 Locking mechanism
6 Locking clip
7 Sensor
8 Control unit
9 Rotation angle sensor
10 Current sensor
9,10 Sensors
11 Drive
v Speed
vₛ Speed threshold
v(t) Speed-time curve
t, t₁, t₂, I(t) Time
i Current
I, Iₛ Current strength

1. A method for controlling a motor vehicle door or a motor vehicle flap,
the motor vehicle door or motor vehicle flap comprising a drive for a leaf of the motor vehicle door or motor vehicle flap that is moved relative to a motor vehicle body, at least one sensor, and a self-learning control unit,
the method comprising the steps of:
with the at least one sensor detecting individual or a plurality of static and/or dynamic parameters of the leaf,
with the self-learning control unit evaluating values of the at least one sensor, wherein the control unit evaluates the static and/or dynamic parameters of the leaf and performs a user identification, and
with the control unit operating the drive in accordance with the user identification.

2. The method according to claim 1, wherein the control unit evaluates the dynamic parameters of the leaf for the purpose of the user identification.

3. The method according to claim 1, wherein the control unit derives the dynamic parameters of the leaf from a movement curve of the leaf associated with a user for the user identification.

4. The method according to claim 1, wherein the control unit evaluates static parameters of the leaf including mass and/or friction of the leaf.

5. The method according to claim 1, wherein the at least one sensor includes a rotation angle sensor, the method further comprising for detecting the dynamic parameters of the leaf with the rotation angle sensor.

6. The method according to claim 1, wherein the at least one sensor includes a current sensor is positioned on the drive, the method further comprising detecting the static parameters of the leaf with the current sensor.

7. The method according to claim 1, wherein the control unit recalibrates the drive as a function of values of the sensor for acting on the leaf based on the user identification.

8. The method according to claim 1, wherein the control unit specifies different operating states including at least one of a normal operation, a load operation and an overload operation as a function of values of the sensor.

9. The method according to claim 1, wherein the control unit carries out the user identification as a function of time-dependent values of the at least one sensor.

10. A device for controlling a motor vehicle door or motor vehicle flap that is configured to perform the method according to claim 1,
the device comprising:
a drive for a leaf of the motor vehicle door or motor vehicle flap that is moved relative to a motor vehicle body,
at least one sensor for detecting individual or a plurality of static and/or dynamic parameters of the leaf, and
a self-learning control unit that evaluates values of the sensor, wherein the control unit evaluates the static and/or dynamic parameters of the leaf for the purpose of a user identification.

11. The device of claim 10, wherein the at least one sensor includes at least of one of a rotation angle sensor and a current sensor.

12. The method according to claim 3, wherein the movement curve of the leaf includes at least one of a path-time curve, a speed-time curve, and an acceleration-time curve.

13. The method according to claim 1, further comprising calibrating the control unit by repeating routines of the static and/or dynamic parameters.

14. The method according to claim 1, further comprising the control unit, based on the values of the at least one sensor, generating a movement profile associated with a user for performing the user identification.

15. The method according to claim 14, further comprising the control unit generating a plurality of movement profiles, each of the plurality of movement profiles corresponding to a different user, and distinguishing between different users to perform the user identification.
